(19) United States
(12) Patent Application Publication
(10) Pub. No.: US 2009/0025290 A1
(43) Pub. Date: Jan. 29, 2009

(54) BOTTOMLESS PLANT CONTAINER

(75) Inventor: Grzegorz Trabka, West Chicago, IL (US)

Correspondence Address: ALAN J. HOWARTH, P.O. BOX 1909, SANDY, UT, 84091-1909, US

(73) Assignee: BALL HORTICULTURAL COMPANY, West Chicago, IL (US)

(21) Appl. No.: 12/180,271

(22) Filed: Jul. 25, 2008

Related U.S. Application Data
(60) Provisional application No. 60/962,122, filed on Jul. 25, 2007.

(51) Int. Cl. A01G 9/10

(52) U.S. Cl. 47/66.7; 47/74

(57) ABSTRACT

A container for growing plants includes a side wall defining an open top, an open bottom, and a cavity for receiving a plant and a plant growth medium. The side wall may be composed of a biodegradable material and may be flexible, yet rigid enough to be self-supporting. The side wall may also be smooth on its outer surface for receiving selected printed indicia, such as product information and growth instructions. In certain embodiments, the side wall may be laminated, contain openings, or have a handle disposed thereon. The container is used by placing a plant and a plant growth medium in the container, then exposing the resulting potted plant to selected conditions of temperature, moisture, and light. The potted plant may also be placed in soil or in a larger container without the need to remove the biodegradable container.

### CROSS-REFERENCE TO RELATED APPLICATIONS

This application claims the benefit of U.S. Provisional Application No. 60/962,122, filed Jul. 25, 2007, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes the above-referenced provisional application.

### STATEMENT REGARDING FEDERALLY SPONSORED RESEARCH OR DEVELOPMENT

Not applicable.

### BACKGROUND OF THE INVENTION

This invention relates to containers for growing, holding, transporting, and planting plants. More particularly, illustrative embodiments of this invention relate to plant containers lacking a bottom wall. Other illustrative embodiments of this invention relate to similar plant containers made of biodegradable materials; having a smooth side wall; and having a flexible, self-supporting side wall.

Numerous containers and pots for growing, holding, transporting, and planting plants have been developed over the years. Illustrative containers and related articles of manufacture include the following.

U.S. Pat. No. 3,785,088 describes a nursery pot having two series of openings in the side wall thereof. Both series of openings permit drainage of excess water from the pot and entry of air into the pot to promote root growth.

U.S. Pat. No. 4,939,865 discloses containers for growing transplantable plants. The container is made by laterally joining a selected number of identical side panels. The side panels are bendable to accommodate the various arcs that are needed for containers of different sizes. Each side panel includes holes in it such that roots growing in the container are air-pruned when they reach the vicinity of the holes. When it is time to transplant the plant, the sides are removed, thus exposing the growth medium and the plant.

U.S. Pat. No. 5,099,607 describes a container for growing plants. The container is made of a strip of flexible material with an inner surface having truncated conical recesses and an outer surface having protuberances in a relative positional arrangement similar to that of the recesses. When the strip is arranged in a cylindrical configuration with opposite ends overlapping, the protuberances in the outer surface of one end nest in the recesses of the inner surface of the other end. Fasteners hold the strip in overlapping, nested engagement.

U.S. Pat. No. 5,331,908 discloses a method of growing perennial plants. The method involves growing a plant in a bottomless container wherein the container is placed on a support surface. The plant is then grown until the root system is sufficiently developed to hold the soil in the container. Then the plant and container are planted as a unit in soil in a field, where growth continues. The plant is harvested by undercutting the roots and removing the container and plant as a unit from the soil.

U.S. Pat. No. 5,382,403 describes packing sphagnum into a paper casing and then cutting the resulting tubular structure into blocks of a selected length. These blocks are mounted in a cutting tray containing pockets for receiving the blocks. Plants are grown in the mounted blocks until they are transferred to plant pots having a larger substrate volume. The casing material gradually decomposes, such that the plant can then freely extend its roots in the plant pot.

U.S. Pat. No. 6,105,308 discloses a growth substrate packed in a casing formed of a dual material comprising a durable open web portion and a disintegrable web-filling or web-covering portion. The web-filling or web-covering portion disintegrates either in the manufacturing process or consequent to exposure to moisture. Thereafter, the open web portion holds the block together while permitting root penetration.

U.S. Patent Application Publication No. 20060241216 discloses an adjustably biodegradable container for plants and overpackaging for containers. This container is made of a printable materials such that indicia can be printed thereon. Such indicia may include the age of the plant, information relating to the producer, information on the conditions of planting, suggestions for growth, and the like. The biodegradable material comprises a mixture of polycaprolactone, polystyrene, and a vegetable load, such as corn flour, wheat flour, and/or cellulose.

U.S. Pat. No. 6,523,306 describes a paper seeding container having a rim, a seam along a vertical dimension, and an overlap in the seam. The bottom end of the container has a twisted and flattened tuft of paper. A fold is provided around the rim for enclosing the overlap crosswise for retaining the shape of the container.

U.S. Pat. No. 7,011,778 discloses placing a loose substrate in a paper casing to form an endless tube, moistening the substrate, and cutting the endless tube into blocks. The blocks are placed into trays, holes are formed in the blocks for receiving cuttings, and the cuttings are placed in the blocks. The trays are then transferred to greenhouse tables in a greenhouse.

U.S. Pat. No. 5,205,473 describes a recyclable corrugated beverage container holder. The holder consists of a tubular liner to which a fluted outer layer adheres. The fluted layer provides insulating air pockets for thermally spacing the hands of the user from the harsh temperatures of the contents of the container.

U.S. Pat. No. 5,425,497 discloses a cup holder defined by a band for mounting on and encircling a cup, the band having an open top and an open bottom through which the cup may extend. The band contains an inner surface that is immediately adjacent to the cup when the cup is received by the band, and this inner surface includes semi-spherically shaped depressions distributed thereon so that each depression defines a non-contacting region of the band, thus creating an air gap between the band and the cup that reduces the rate of heat transfer through the cup holder.

While prior plant containers and methods of use thereof are known and are generally suitable for their limited purposes, they possess certain inherent deficiencies that detract from their overall utility in horticulture.

In view of the foregoing, it will be appreciated that providing a bottomless pot for plants would be a significant advancement in the art.

### BRIEF SUMMARY OF THE INVENTION

An illustrative embodiment of a plant container according to the present invention comprises a flexible side wall that is sufficiently rigid to be self supporting, the side wall defining an open top, an open bottom, and a cavity for receiving a plant growth medium and a plant. The side wall may be comprised of a biodegradable material. Further, the side wall may be laminated and/or comprise a smooth outer surface adapted for being printed with selected indicia, such as product information, growing instructions, trademarks, decorative designs, and the like. Still further, the side wall may comprise at least one opening therein. Another illustrative embodiment of the invention may comprise a handle disposed thereon. The side wall may be folded to permit the container to be stored in a substantially flattened configuration.

In another illustrative embodiment of the invention, the container comprises a biodegradable material, for example about 10-100% by weight of polylactic acid and, optionally, about 0-90% by weight of a vegetable load. The vegetable load may comprise a starch, a flour, or a cellulose, or a mixture thereof. In another illustrative embodiment of the invention, the biodegradable material comprises about 10-100% by weight of polyhydroxyalkanoate and, optionally, about 0-90% by weight of a vegetable load. In still another illustrative embodiment of the invention, the biodegradable material comprises about 10-100% by weight of calcium carbonate and, optionally, about 0-90% by weight of a vegetable load. In yet another illustrative embodiment of the invention, the biodegradable material comprises a cellulosic material. The cellulosic material may further comprise a water-resistant material. The biodegradable material may further comprise a plant nutrient or a pesticide.

An illustrative method of growing a plant according to the present invention comprises

(a) placing a plant and a first plant growth medium in a container comprising a flexible side wall that is sufficiently rigid to be self supporting, the side wall defining an open top, an open bottom, and a cavity for receiving the first plant growth medium and the plant; and

(b) exposing the plant, first plant growth medium, and biodegradable container to selected conditions of temperature, moisture, and light. The method may further comprise placing the combined plant, first plant growth medium, and biodegradable container in a second plant growth medium, such as soil in a field, bed, or larger container, without the need for removing the biodegradable container.

### BRIEF DESCRIPTION OF THE SEVERAL VIEWS OF THE DRAWINGS

FIG. 1 shows a perspective view of an illustrative embodiment of the present invention in an opened configuration.

FIG. 2 shows a top view of embodiment of FIG. 1 in a partially opened configuration.

FIG. 3 shows a top view of the embodiment of FIG. 1, opened further than the position shown in FIG. 2.

FIG. 4 shows a side view of the embodiment of FIG. 1 in a flat position.

FIG. 5 shows a top view of the embodiment of FIG. 1 in a completely opened configuration.

FIG. 6 shows a side view of the embodiment of FIG. 1 in a completely opened configuration.

FIG. 7 shows the side wall of the embodiment of FIG. 1, wherein the seam was opened such that the side wall lies in one plane.

FIGS. 8-10 show top views of other illustrative embodiments of the present invention, wherein the side wall of each embodiment is in an open configuration lying in one plane.

FIG. 11 shows a perspective view of another illustrative embodiment of the present invention.

FIG. 12 shows a top view of another illustrative embodiment of the present invention, wherein the side wall is in an open configuration lying in one plane.

FIG. 13 shows a perspective view of another illustrative embodiment of the present invention, wherein a handle is disposed on the side wall.

### DETAILED DESCRIPTION

Before the present bottomless plant container and methods are disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

The publications and other reference materials referred to herein to describe the background of the invention and to provide additional detail regarding its practice are hereby incorporated by reference. The references discussed herein are provided solely for their disclosure prior to the filing date of the present application. Nothing herein is to be construed as an admission that the inventors are not entitled to antedate such disclosure by virtue of prior invention.

It must be noted that, as used in this specification and the appended claims, the singular forms “a,” “an,” and “the” include plural referents unless the context clearly dictates otherwise. Thus, for example, reference to“a plant” includes two or more plants, reference to “a biodegradable material” includes reference to a mixture of two or more biodegradable materials, and reference to “a plant growth medium” includes reference to a mixture of two or more plant growth media.

Unless defined otherwise, all technical and scientific terms used herein have the same meanings as commonly understood by one of ordinary skill in the art to which this invention belongs.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.” As used herein, “consisting of” and grammatical equivalents thereof exclude any element, step, or ingredient not specified in the claim. As used herein, “consisting essentially of” and grammatical equivalents thereof limit the scope of a claim to the specified materials or steps and those that do not materially affect the basic and novel characteristic or characteristics of the claimed invention.

As used herein, “plant” includes a propagule thereof. Thus, reference to a plant container according to the present invention for receiving “a plant” includes reference to a seed, a spore, a cutting, and any other part of the vegetative body capable of independent growth if detached from the parent.

As used herein, “polyhydroxyalkanoate” means any of a family of biodegradable linear polyesters produced by bacterial fermentation of sugars or lipids. Polyhydroxyalkanoates (PHAs) are polymers of 3-, 4-, 5-, and 6-hydroxyalkanoic acids. PHAs are classified into two types, short chain length PHAs with C₃-C₅ hydroxyacids and medium chain length PHAs with C₆-C₁₆ hydroxyacids. The composition of the polymers is governed by the bacterial strain being used and the carbon source upon which the bacteria grow. Thus, their physical properties and rate of degradation can be altered by changing the bacterial source of the polymer and the corresponding fermentation conditions used. They can include thermoplastic or elastomeric materials with melting points ranging from about 40° C. to 180° C. The mechanical properties and biocompatibility of PHAs can also be changed by blending, modifying the surface, or combining PHAs with other polymers, enzymes, and inorganic materials.

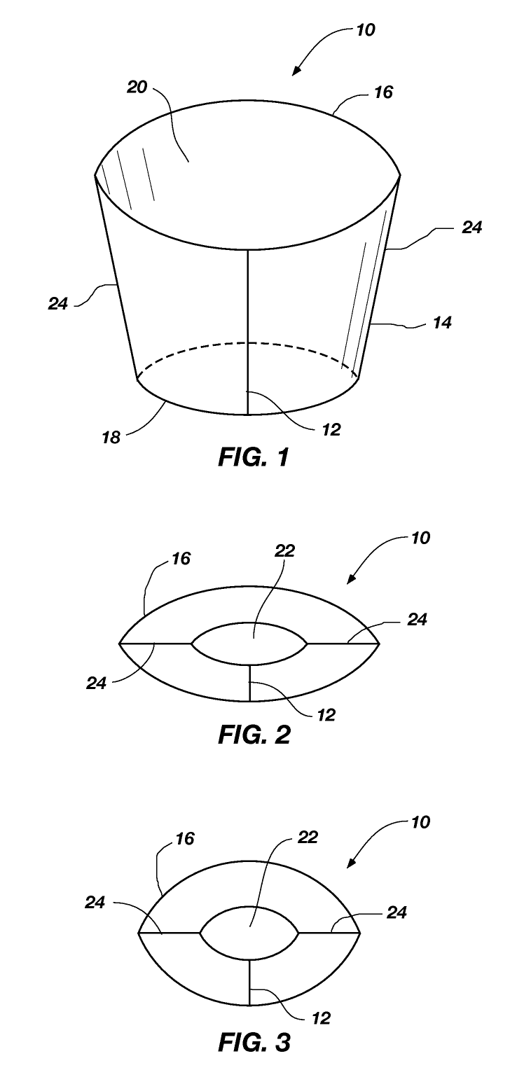

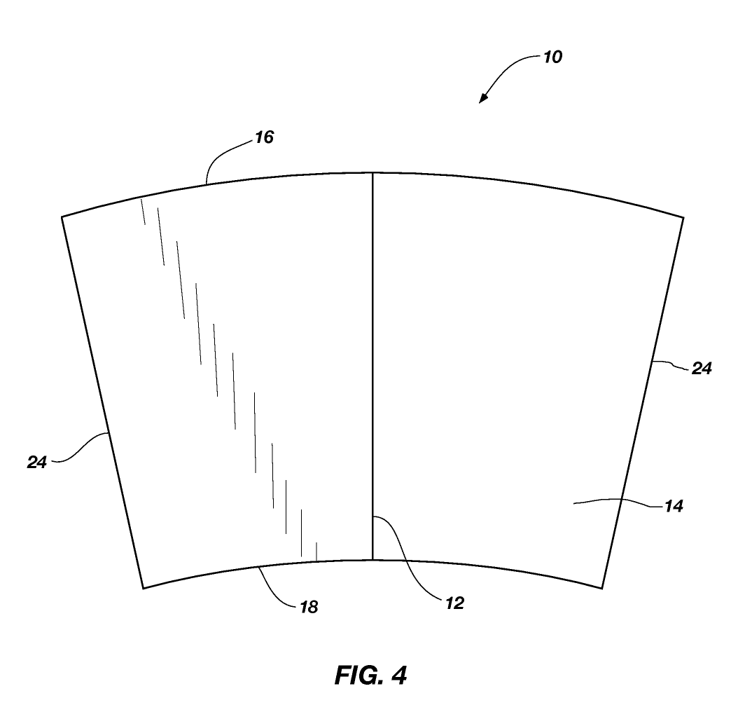

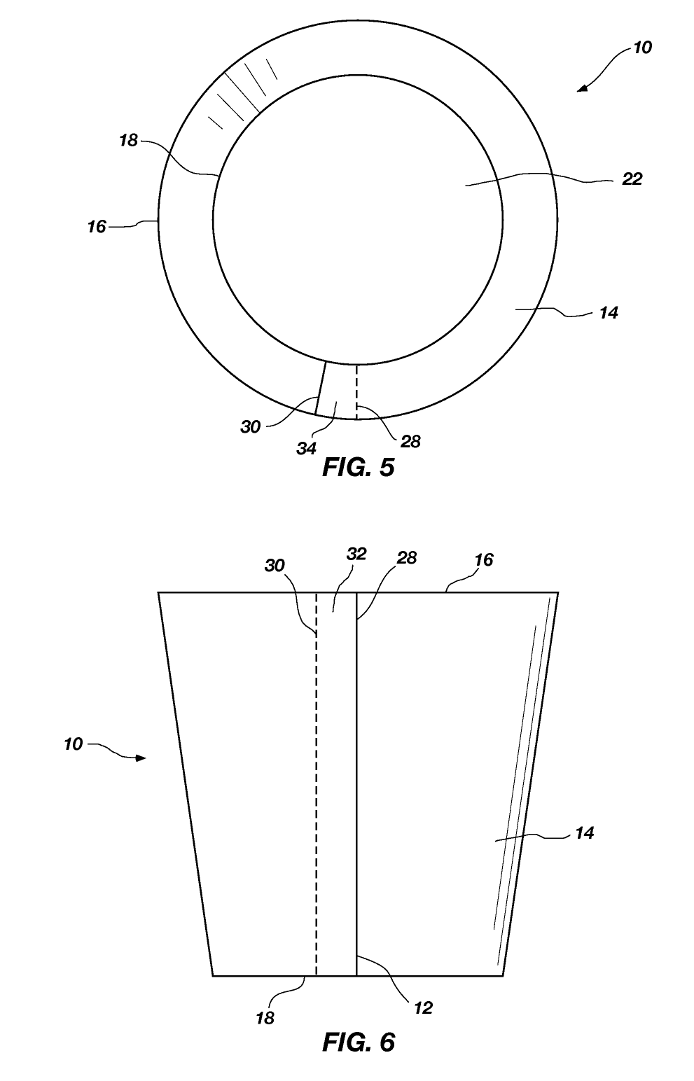

Referring now to FIGS. 1-4, there is shown a bottomless container, indicated generally at 10. The container 10 may be formed of a strip of biodegradable material joined at a seam 12 to form a loop or sleeve with openings at both the top and bottom. Thus, the container 10 comprises a side wall 14 having a top edge 16 and a bottom edge 18. The side wall 14 defines a top opening 20 and a bottom opening 22. The side wall 14 may be tapered to assist in maintaining contents in the container 10. The container 10 may optionally include folds 24 on opposite sides of the container 10 so that the container 10 may be placed in a flat configuration, as shown in the side view of the container 10 in FIG. 4. Accordingly, several containers 10 may be stacked together in a compact arrangement. When the container resides in a flat configuration, a side view of the container 10 shows that the top edge 16 and a bottom edge 18 may appear curved, as shown in FIG. 4. When the container resides in an opened configuration, such as is illustrated in FIG. 5, then a side view of the container 10 shows that the top edge 16 and the bottom edge 18 may appear flat, as shown in FIG. 6.

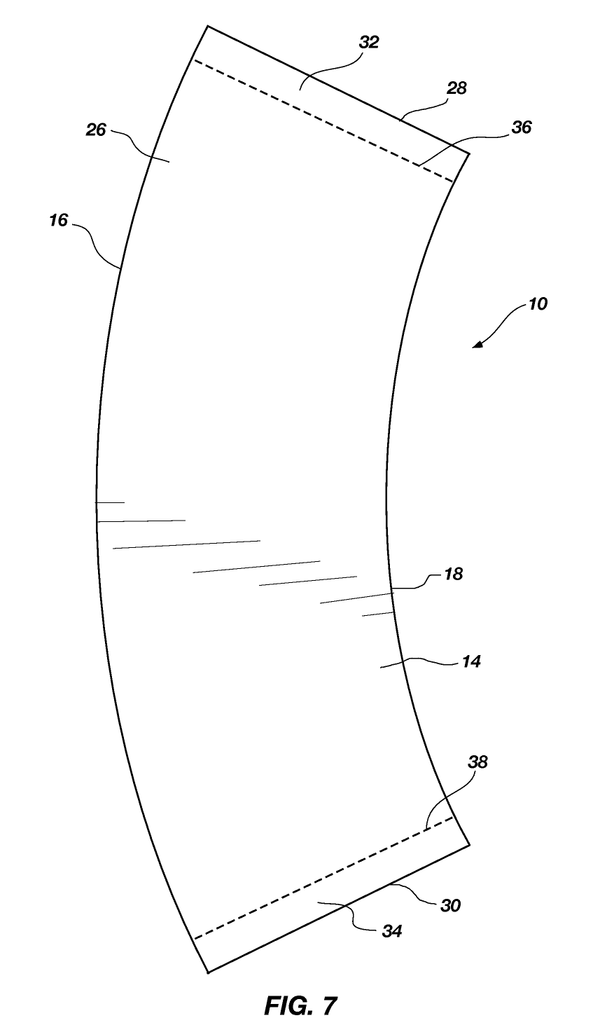

Referring now to FIG. 7, there is shown a strip 26 of material prior to its being formed into a container 10. The strip 26 contains two generally arcuate edges that will form the top edge 16 and the bottom edge 18 of the container 10. The strip also contains a first end 28 and a second end 30. The container 10 is made by bringing the first end 28 and the second end 30 adjacent to each other with a first portion 32 of the side wall 14 adjacent to first end 28 overlapping a second portion 34 of the side wall 14 adjacent to second end 30. The dashed lines 36, 38 show the extent of the areas of overlap. Illustratively, an adhesive may be used to cause the first portion 32 and the second portion 34 to adhere to each other, thus forming the container 10. Alternatively, the first portion 32 and the second portion 34 may be caused to adhere to each other by heat sealing according to methods well known in the art. Overlapping of the first portion 32 and the second portion 34 forms the seam 12. Alternatively, one or more fasteners may be used to fasten the first portion 32 and second portion 34 to each other. FIGS. 5 and 6 also illustrate the overlap of the first portion 32 and the second portion 34, with the first end 28 shown in phantom in FIG. 5 and the second end 30 shown in phantom in FIG. 6.

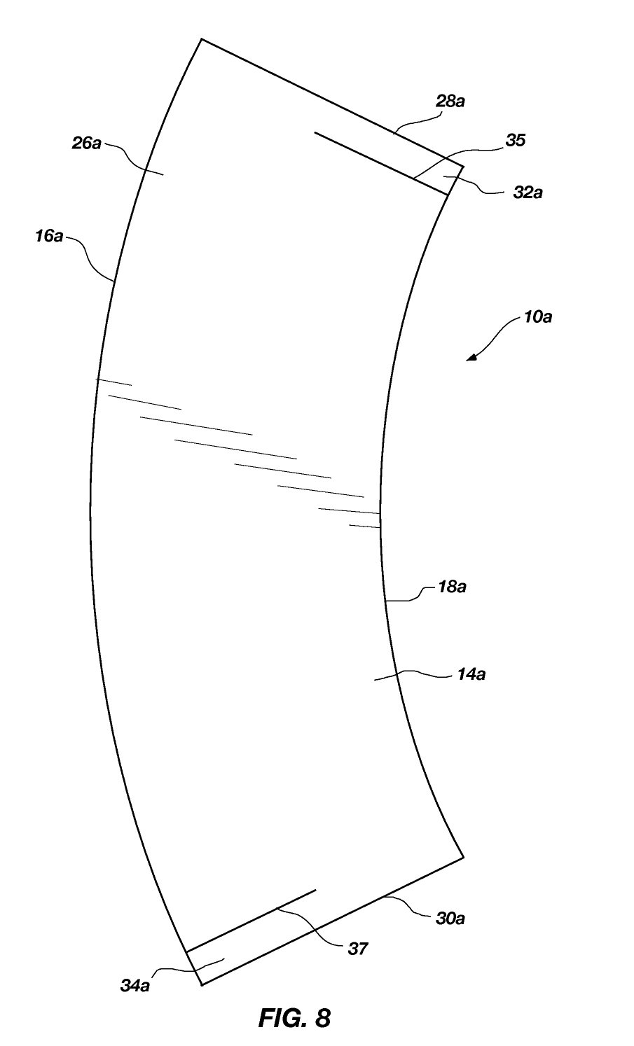

FIG. 8 shows another illustrative embodiment of the invention wherein a strip 26a of material prior to its being formed into a container 10a is shown. The strip 26a contains two generally arcuate edges that will form the top edge 16a and the bottom edge 18a of the container 10a. The strip also contains a first end 28a and a second end 30a. A cut or slit 35 and 37 is made in the first end 28a and the second end 30a, respectively, to form tabs 32a and 34a. The container 10a is made by bringing the first end 28a and the second end 30a adjacent to each other and sliding tab 32a into slit 37 and tab 34a into slit 35 to form an interlocking joint that fastens the first end 28a and the second end 30a to each other.

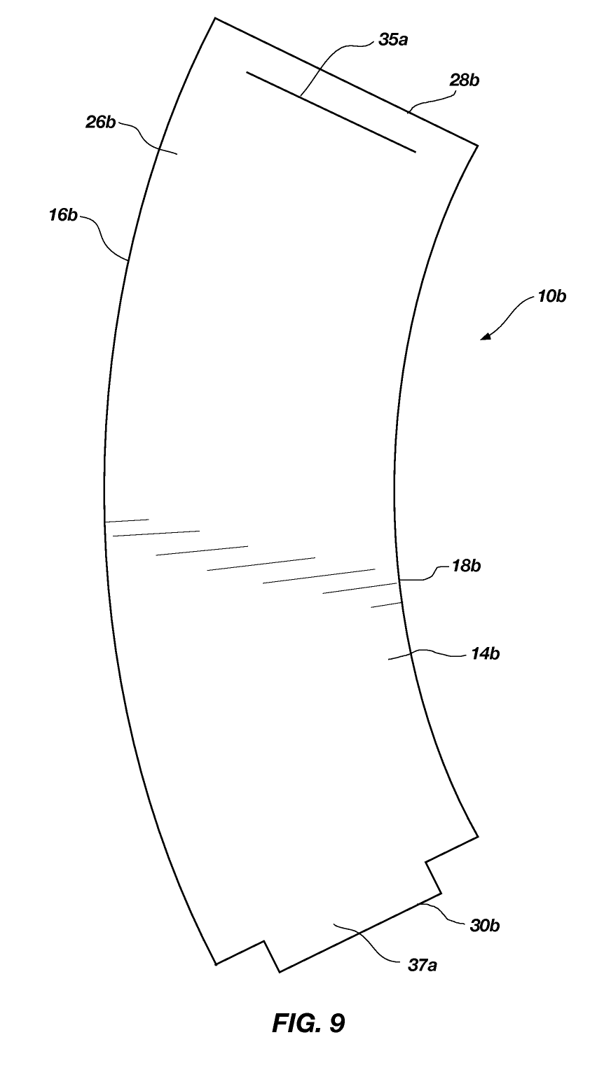

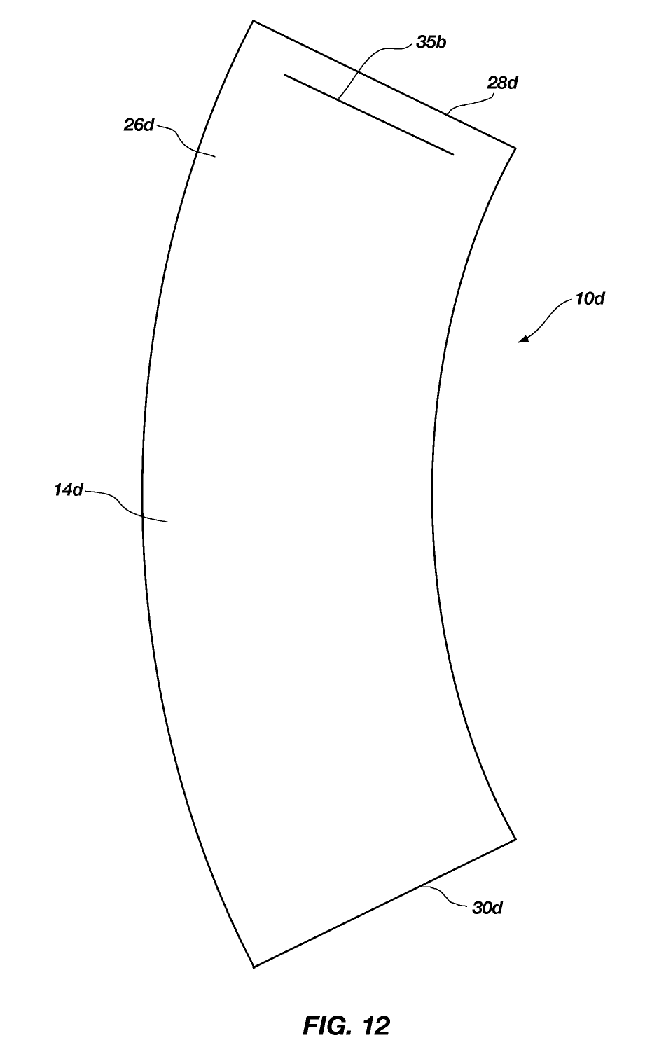

FIG. 9 shows another illustrative embodiment of the invention wherein a strip 26b of material prior to its being formed into a container 10b is shown. The strip 26b contains two generally arcuate edges that will form the top edge 16b and the bottom edge 18b of the container 10b. The strip 26b also contains a first end 28b and a second end 30b. A cut or slit 35a is made in the first end 28a, and a tab 37a is formed in the second end 30b. The container 10b is made by bringing the first end 28b and the second end 30b adjacent to each other and inserting tab 37a into slit 35a, which fastens the first end 28b and the second end 30b to each other. Alternatively, a strip 16 as shown in FIG. 7 can be formed into a container 10 by using a fastener wherein a first portion of the fastener, which may be disposed on first end 28, comprises a tab, and a second portion of the fastener, which may be disposed on second end 30, comprises a slot. The fastener is used by inserting the tab on the first portion of the fastener into the slot in the second portion of the fastener. Alternatively, FIG. 12 shows a strip 26d that can be formed into a container 10d by using a fastener. Strip 26d contains a first end 28d and a second end 30d, wherein the first end 28d comprises a slit 35b. The fastener comprises a tab portion that may be inserted into slit 35b and an adhesive portion that may be disposed on the second end 30d, thus effectively joining the first end 28d and the second end 30d and resulting in the container 10d.

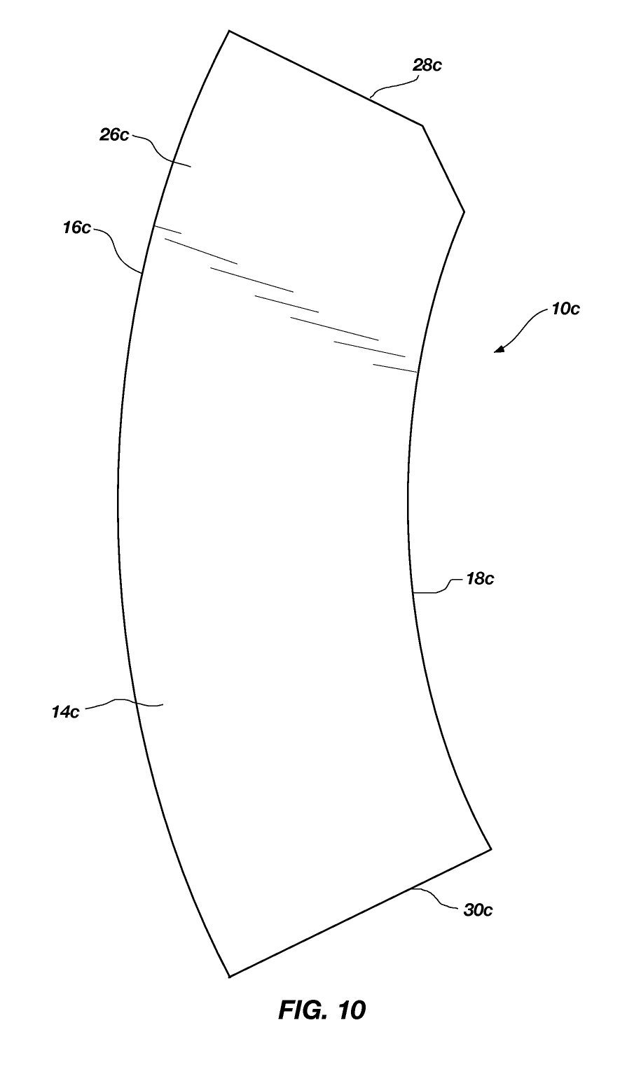

FIG. 10 shows still another illustrative embodiment of the invention wherein a strip 26c of material prior to its being formed into a container 10c is shown. The strip 26c contains two generally arcuate edges that will form the top edge 16c and the bottom edge 18c of the container 10c. The strip 26c also contains a first end 28c and a second end 30c. The container is made by bringing the first end 28c and the second end 30c adjacent to each other and fastening them to each other, such as with an adhesive, one or more fasteners, tab-in-slit fastening, or the like.

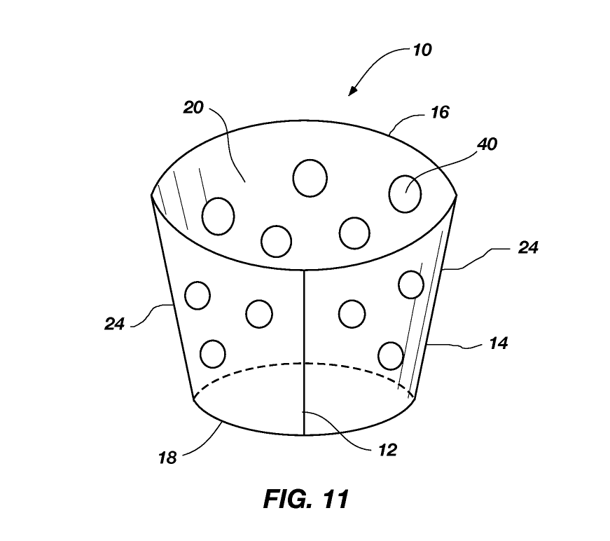

FIG. 11 shows another illustrative embodiment of the invention, wherein the side wall 14 contains holes 40 formed therein. The holes permit water and air to flow more freely to the plant growth medium contained in the container, and thus to the roots of the plant. If the plant, plant growth medium, and container are placed as a unit in another plant growth medium, such as soil in a field, bed, or larger container, then the roots of the plant may grow and extend through the holes 40 in the side wall.

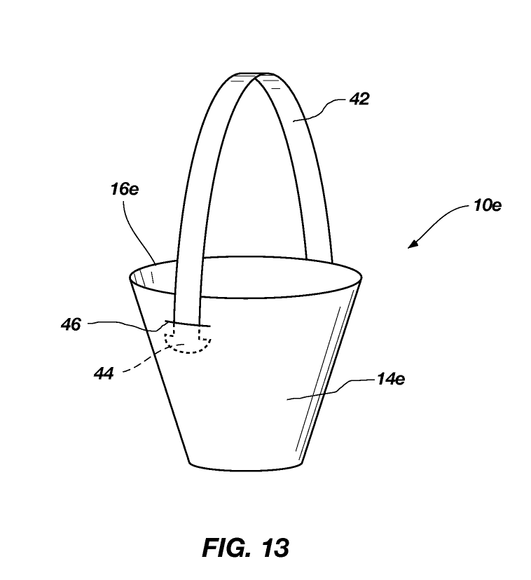

FIG. 13 shows still another illustrative embodiment of the invention, wherein the container 10e further comprises a handle 42 disposed on the side wall 14e at or adjacent to the top edge 16e. The handle 42 can be attached to the side wall 14e with adhesives or fasteners, according to methods well known in the art. Alternatively, each end of the handle 42 can comprise a tab 44 that can be inserted through a slit 46 in the side wall 14e.

As shown in FIGS. 7-10 and 12-13, the container 10-10e may have a sidewall 14-14e having a smooth surface for receiving any of a variety of indicia, such as decorations, instructions, advertisements, and the like. The container 10-10e may be formed of a flexible material so the container 10-10e may be opened to form a substantially tubular configuration, as shown in FIGS. 1, 3, 5, and 6. The top opening may be larger than the bottom opening such that the container has the appearance of a truncated cone. Also, the container 10-10e may have sufficient rigidity to maintain a shape whether or not soil is placed in the container 10-10e. That is, the container 10-10e may be sufficiently rigid to be self-supporting. The container 10-10e may optionally be constructed as a single layer, as multiple layers, or having a laminated structure.

The container 10-10e may be made of a biodegradable material such that plants may be planted in soil in the container, and the container will degrade over time such that roots may pass through the side of the container 10-10e into surrounding soil. Also, since the bottom of the container 10-10e is open, roots may pass through the bottom of the container 10-10e. The container 10-10e can be planted directly into a larger pot or in soil, such as in a flower bed or a field.

The biodegradable material that is used for making the biodegradable pot according to the present invention may be of any of several types. A first illustrative material comprises about 10-100% by weight ofthe polyester, polylactic acid (PLA). Optionally, this first material may also comprise about 0-90% by weight of a vegetable load mixed with the PLA. Illustrative compositions that may comprise the vegetable load include starches, flours, celluloses, or the like, or mixtures thereof. The starches, flours, and celluloses can be from any plant. For example, starches that can be used according to the present invention can include cornstarch, rice starch, wheat starch, or the like. Similarly, flours and celluloses that can be used according to the present invention include flours and celluloses from a variety of plant sources, such as corn, wheat, rice, barley, oats, or the like.

A second illustrative material that can be used for making the biodegradable container according to the present invention comprises about 10-100% by weight of a polyhydroxyalkanoate polyester (PHA). As in the first material, the second material may also optionally comprise about 0-90% by weight of a vegetable load mixed with the PHA, wherein the vegetable load may comprise starches, flours, celluloses, or the like, or mixtures thereof, as described above in connection with the first material.

A third illustrative material that can be used for making the biodegradable container according to the present invention comprises about 10-100% by weight of calcium carbonate (CaCO₃). As in the first and second materials, the third material may also optionally comprise about 0-90% by weight of a vegetable load mixed with the calcium carbonate, wherein the vegetable load may comprise starches, flours, celluloses, or the like, or mixtures thereof, as described above.

A fourth illustrative material that an be used for making the biodegradable container according to the present invention comprises a cellulosic material, typically incorporating a water-resistant material therein, or at least on the surface thereof.

In an illustrative embodiment of the invention, the side wall of the container may be constructed of any of the suitable biodegradable materials, and the side wall may be laminated with a biodegradable plastic, such as PHA.

The biodegradable material can also include nutrients, pesticides, and similar ingredients to stimulate growth and control fungi, insects, and other pests or disease agents. Upon wetting and degradation of the material, these amendments can leach into the plant growth medium to carry out their beneficial effects.

Biodegradable papers can be made of these biodegradable materials according to methods well known in the art of paper making. The resulting biodegradable papers can be printed with indicia of any selected type, such as with decorative indicia, trademarks, product information, watering instructions, and the like. The biodegradable papers can also be cut, folded, and fastened to result in the plant container.

The bottomless container of the present invention can be used for growing plants by placing a selected plant growth medium, such as soil or potting mix, into the pot and placing one or more seeds or other propagules in the plant growth medium. Similarly, a seedling may be transplanted or a cutting may be rooted in the plant growth medium. The plant can be exposed to selected environmental conditions of temperature, moisture, and light to permit the plants to grow. At a selected time, the pot and the plant it contains can be planted as a unit in a field, flowerbed, larger pot, or other selected location.

The subject matter claimed is:

1. A plant container comprising a flexible side wall that is biodegradable and sufficiently rigid to be self-supporting, the side wall defining an open top, an open bottom, and a cavity for receiving a plant growth medium and a plant.

2. The plant container of claim 1 wherein the side wall is laminated.

3. The plant container of claim 1 wherein the side wall comprises a smooth outer surface adapted for being printed with selected indicia.

4. The plant container of claim 1 wherein the side wall comprises at least one opening therein.

5. The plant container of claim 1 further comprising a handle disposed thereon.

6. The plant container of claim 1 wherein the side wall is folded to permit the plant container to be stored in a substantially flattened configuration.

7. The plant container of claim 2 wherein the biodegradable material comprises about 10-100% by weight of polylactic acid and, optionally, about 0-90% by weight of a vegetable load.

8. The plant container of claim 7 wherein the vegetable load comprises a starch, a flour, a cellulose, or a mixture thereof.

9. The plant container of claim 2 wherein the biodegradable material comprises 10-100% by weight of polyhydroxyalkanoate and, optionally, about 0-90% by weight of a vegetable load.

10. The plant container claim 9 wherein the vegetable load comprises a starch, a flour, or a cellulose, or a mixture thereof.

11. The plant container of claim 2 wherein the biodegradable material comprises about 10-100% by weight of calcium carbonate and, optionally, about 0-90% by weight of a vegetable load.

12. The plant container of claim 11 wherein the vegetable load comprises a starch, a flour, or a cellulose, or a mixture thereof.

13. The plant container of claim 2 wherein the biodegradable material comprises a cellulosic material.

14. The plant container of claim 13, wherein the cellulosic material further comprises a water-resistant material.

15. The plant container of claim 2 wherein the biodegradable material comprises a plant nutrient, a pesticide, or a mixture thereof.

16. A method of growing a plant, comprising
(a) placing a plant and a first plant growth medium in a container comprising a flexible side wall that is biodegradable and sufficiently rigid to be self-supporting, the side wall defining an open top, an open bottom, and a cavity for receiving a plant growth medium and a plant; and
(b) exposing the plant, first plant growth medium, and biodegradable container to selected conditions of temperature, moisture, and light.

17. The method of claim 16 wherein the side wall is laminated.

18. The method of claim 16 wherein the side wall comprises a smooth outer surface adapted for being printed with selected indicia.

19. The method of claim 16 wherein the side wall comprises at least one opening therein.

20. The method of claim 16 further comprising a handle disposed thereon.

21. The method of claim 16 wherein the side wall is folded to permit the container to be stored in a substantially flattened configuration.

22. The method of claim 17 wherein the biodegradable material comprises about 10-100% by weight of polylactic acid and, optionally, about 0-90% by weight of a vegetable load.

23. The method of claim 21 wherein the vegetable load comprises a starch, a flour, or a cellulose, or a mixture thereof.

24. The method of claim 17 wherein the biodegradable material comprises 10-100% by weight of a polyhydroxyalkanoate and, optionally, about 0-90% by weight of a vegetable load.

25. The method of claim 24 wherein the vegetable load comprises a starch, a flour, or a cellulose, or a mixture thereof.

26. The method of claim 17 wherein the biodegradable material comprises about 10-100% by weight of calcium carbonate and, optionally, about 0-90% by weight of a vegetable load.

27. The method of claim 26 wherein the vegetable load comprises a starch, a flour, or a cellulose, or a mixture thereof.

28. The method of claim wherein the biodegradable material comprises a cellulosic material.

29. The method of claim 28, wherein the cellulosic material further comprises a water-resistant material.

30. The method of claim 17 wherein the biodegradable material comprises a plant nutrient, a pesticide, or a mixture thereof.
